(19) United States
(12) Patent Application Publication
(10) Pub. No.: US 2022/0029645 A1
(43) Pub. Date: Jan. 27, 2022

(54) Antenna assembly for wireless communication devices

(71) Applicant: Teknologian tutkimuskeskus VTT Oy, Espoo (FI)

(72) Inventor: Jussi Säily, Espoo (FI)

(21) Appl. No.: 17/297,156

(22) PCT Filed: Nov. 20, 2019
(86) PCT No.: PCT/FI2019/050827

§ 371 Date: May 26, 2021

(30) Foreign Application Priority Data
Nov. 29, 2018 (FI) 20186019

(51) Int. Cl. H04B 1/00; H04B 1/18; H04B 1/30

(52) U.S. Cl. CPC H04B 1/0057; H04B 1/30; H04B 1/18

(57) ABSTRACT

According to an example aspect of the present invention, there is provided an antenna assembly for millimeter-wave signals, comprising a first diplexer coupled with a baseband unit and an oscillator, a second diplexer coupled with a first port of a frequency mixer for millimeter-wave signals and connected to a second port of the frequency mixer for millimeter-wave signals, a waveguide coupled with the first diplexer and the second diplexer, and the frequency mixer for millimeter-wave signals being connected to an antenna via a third port of the frequency mixer for millimeter-wave signals.

### FIELD

Embodiments of the present invention relate in general to wireless communication devices and more specifically, to an antenna assembly for such devices.

### BACKGROUND

In general, higher frequency bands have more bandwidth available for wireless communication and as the demand for wireless communications increases, it has become desirable to exploit millimeter-waves for such communications. Consequently, current standardization efforts in the field of wireless communications consider the use of millimeter-waves. For example, 3rd Generation Partnership Project, 3GPP, develops 5G technology, which may be referred to as New Radio, NR, radio access technology as well, and considers the use of millimeter-wave frequency bands at least for 5G/NR.

Similar enhancements may also be employed in other cellular networks and in several other wireless communication networks as well, such as, for example, in Wireless Local Area Networks, WLANs. However, the use of millimeter-waves for communication also brings additional challenges because a millimeter-wave signal typically experiences higher path losses compared to a lower frequency signal. There is therefore a need to provide an improved antenna assembly for wireless devices that use millimeter-waves for wireless communications.

### SUMMARY OF THE INVENTION

According to some aspects, there is provided the subject-matter of the independent claims. Some embodiments are defined in the dependent claims.

According to a first aspect of the present invention, there is provided an antenna assembly for millimeter-wave signals, comprising a first diplexer coupled with a baseband unit and an oscillator, a second diplexer coupled with a first port of a frequency mixer for millimeter-wave signals and connected to a second port of the frequency mixer for millimeter-wave signals, a waveguide coupled with the first diplexer and the second diplexer and the frequency mixer for millimeter-wave signals being connected to an antenna via a third port of the frequency mixer for millimeter-wave signals.

According to the first aspect of the present invention, the antenna assembly may further comprise a processing unit comprising the baseband unit and the oscillator.

According to the first aspect of the present invention, the antenna assembly may further comprise a processing unit comprising the first diplexer. Alternatively, the antenna assembly may comprise a processing unit coupled to the first diplexer.

According to the first aspect of the present invention, the antenna assembly may comprise a phase shifter coupled to the baseband unit and the first diplexer.

According to the first aspect of the present invention, the frequency mixer for millimeter-wave signals may be coupled to the antenna via the third port.

According to the first aspect of the present invention, the antenna assembly may be for Frequency Division Duplexed, FDD, transmissions.

According to the first aspect of the present invention, the antenna assembly may further comprise a first switch coupled to the second diplexer and to the frequency mixer for millimeter-wave signals and a second switch coupled to the frequency mixer for millimeter-wave signals and the antenna. In some embodiments, the second diplexer may be connected to the second port of the frequency mixer for millimeter-wave signals via the first switch and the frequency mixer for millimeter-wave signals is connected to the antenna via the second switch.

According to the first aspect of the present invention, the antenna assembly may be for Time Division Duplexed, TDD, transmissions.

According to the first aspect of the present invention, the waveguide may be for microwave signals, possibly for microwave signals under 10 GHz.

According to the first aspect of the present invention, the waveguide may be mounted on a Printed Circuit Board, PCB.

According to a second aspect of the present invention, there is provided an antenna array comprising an antenna assembly according to the first aspect of the present invention, wherein the antenna assembly forms an antenna chain of the antenna array and the antenna array comprises a plurality of said antenna chains.

According to a third aspect of the present invention, there is provided a wireless terminal comprising the antenna assembly according to the first aspect or the antenna array of the second aspect of the present invention.

According to a fourth aspect of the present invention, there is provided a wireless terminal according to the third aspect of the present invention, wherein the wireless terminal is a User Equipment, UE.

### BRIEF DESCRIPTION OF THE DRAWINGS

FIG. 1 illustrates an exemplary network scenario in accordance with at least some embodiments of the present invention;

FIG. 2 illustrates an example apparatus capable of supporting at least some embodiments of the present invention;

FIG. 3 illustrates an example structure of a wireless device in accordance with at least some embodiments of the present invention;

FIG. 4 illustrates an exemplary antenna assembly for a single transmitter chain in accordance with at least some embodiments of the present invention;

FIG. 5 illustrates an exemplary antenna assembly for a single receiver chain in accordance with at least some embodiments of the present invention;

FIG. 6 illustrates an exemplary TDD multiplexing concept in accordance with at least some embodiments of the present invention;

FIG. 7 illustrates an exemplary transmit antenna array concept in accordance with at least some embodiments of the present invention;

FIG. 8 illustrates an exemplary receive antenna array concept in accordance with at least some embodiments of the present invention.

### EMBODIMENTS

Operation of wireless devices that use millimeter-waves for communications may be improved by the procedures described herein. More specifically, an antenna assembly for a wireless device may comprise two diplexers and a waveguide between said two diplexers. A first diplexer may be located at or near a processing unit and a second diplexer may be located close to an antenna. In some embodiments, the first diplexer may generate a multiplexed signal by frequency division multiplexing a baseband signal and an oscillator signal, and transmit the multiplexed signal to the second diplexer via the waveguide. The second diplexer may regenerate the baseband signal and the oscillator signal by demultiplexing the multiplexed signal. A millimeter-wave signal for wireless communication may be generated based on the regenerated baseband signal and the oscillator signal.

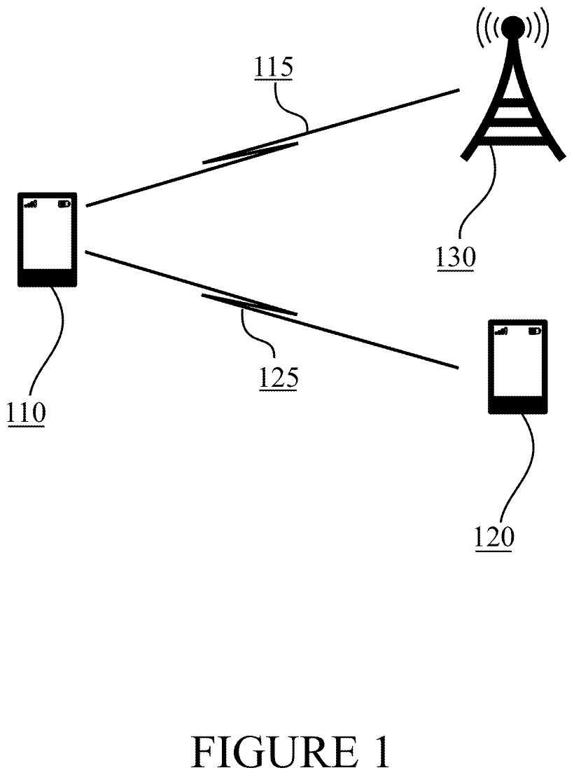

FIG. 1 illustrates an exemplary network scenario in accordance with at least some embodiments of the present invention. According to the example scenario of FIG. 1, there may be a wireless communication system, which comprises first wireless terminal 110, second wireless terminal 120 and wireless network node 130. Wireless terminal 110 may be connected to wireless network node 130 via air interface 115. In addition, or alternatively, wireless terminal 110 may be connected to wireless terminal 120 via air interface 125. Wireless terminals 110, 120 and/or wireless network node 130 may comprise an antenna assembly in accordance with at least some embodiments of the present invention.

Wireless terminals 110, 120 may comprise, for example, a User Equipment, UE, a smartphone, a cellular phone, a Machine-to-Machine, M2M, node, Machine-Type Communications node, an Internet of Things, IoT, node, a car telemetry unit, a laptop computer, a tablet computer or, indeed, another kind of suitable wireless terminal or mobile station. In the example system of FIG. 1, wireless terminal 110 may communicate wirelessly with wireless network node 130, or a cell of wireless network node 130, via air interface 115. Wireless network node 130 may be considered as a serving Base Station, BS, for wireless terminal 110. Air interface 115 between wireless terminal 110 and wireless network node 130 may be configured in accordance with a first Radio Access Technology, RAT, which both wireless terminal 110 and wireless network node 130 are configured to support. Similarly, air interface 125 between wireless terminal 110 and wireless terminal 120 may be configured in accordance with a second RAT, which both wireless terminal 110 and wireless terminal 120 are configured to support. The first and second RATs may, or may not, be the same.

Examples of cellular RATs include Long Term Evolution, LTE, New Radio, NR, which may also be known as fifth generation, 5G, radio access technology and MulteFire. On the other hand, examples of non-cellular RATs include Wireless Local Area Network, WLAN, and Worldwide Interoperability for Microwave Access, WiMAX. In case of cellular networks, wireless network node 130 may be referred to as a BS. For example, in the context of LTE, wireless network node 130 may be referred to as eNB while in the context of NR, wireless network node 130 may be referred to as gNB. Also, for example in the context of WLAN, wireless network node 130 may be referred to as an access point. Wireless terminals 110 and 120 may be similarly referred to as user equipments, mobile stations or end-user devices in general. In any case, embodiments of the present invention are not restricted to any particular wireless technology. Instead, embodiments of the present invention may be exploited in any wireless communication system. Wireless terminals and wireless network nodes may be referred to as wireless devices in general.

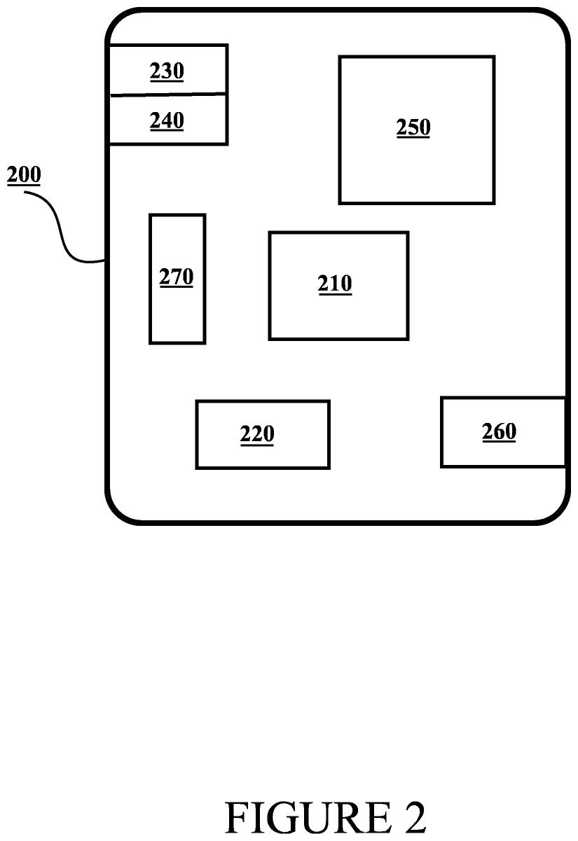

FIG. 2 illustrates an example apparatus capable of supporting at least some embodiments. Illustrated is device 200, which may comprise, for example, wireless terminal 110, 120 or wireless network node 130 FIG. 1. Comprised in device 200 is processing unit 210, which may comprise, for example, a single- or multi-core processor wherein a single-core processor comprises one processing core and a multi-core processor comprises more than one processing core. Processing unit 210 may comprise, in general, a control device. Processing unit 210 may comprise more than one processor. Processing unit 210 may be a control device. Processing unit 210 may comprise, for example, a Cortex-A8 processing core manufactured by ARM Holdings or a Steamroller processing core produced by Advanced Micro Devices Corporation. Processing unit 210 may comprise at least one Qualcomm Snapdragon and/or Intel Atom processor. Processing unit 210 may comprise at least one Application-Specific Integrated Circuit, ASIC. Processing unit 210 may comprise at least one Field-Programmable Gate Array, FPGA. Processing unit 210 may be means for performing method steps in device 200. Processing unit 210 may be configured, at least in part by computer instructions, to perform actions.

Device 200 may comprise memory 220. Memory 220 may comprise Random-Access Memory, RAM, and/or permanent memory. Memory 220 may comprise at least one RAM chip. Memory 220 may comprise solid-state, magnetic, optical and/or holographic memory, for example. Memory 220 may be at least in part accessible to processing unit 210. Memory 220 may be at least in part comprised in processing unit 210. Memory 220 may be means for storing information. Memory 220 may comprise computer instructions that processing unit 210 is configured to execute. When computer instructions configured to cause processing unit 210 to perform certain actions are stored in memory 220, and device 200 overall is configured to run under the direction of processing unit 210 using computer instructions from memory 220, processing unit 210 and/or its at least one processing core may be considered to be configured to perform said certain actions. Memory 220 may be at least in part comprised in processing unit 210. Memory 220 may be at least in part external to device 200 but accessible to device 200.

Device 200 may comprise a transmitter 230. Device 200 may comprise a receiver 240. Transmitter 230 and receiver 240 may be configured to transmit and receive, respectively, information in accordance with at least one cellular or non-cellular standard. Transmitter 230 may comprise more than one transmitter. Receiver 240 may comprise more than one receiver. Transmitter 230 and/or receiver 240 may be configured to operate in accordance with Global System for Mobile communication, GSM, Wideband Code Division Multiple Access, WCDMA, 5G/NR, Long Term Evolution, LTE, IS-95, Wireless Local Area Network, WLAN, Worldwide Interoperability for Microwave Access, WiMAX, and/or Ethernet standards, for example. An antenna assembly according to at least some embodiments of the present invention may form transmitter 230 and/or receiver 240, or a part of transmitter 230 and/or receiver 240.

Device 200 may comprise a Near-Field Communication, NFC, transceiver 250. NFC transceiver 250 may support at least one NFC technology, such as Bluetooth, Wibree or similar technologies.

Device 200 may comprise User Interface, UI, 260. UI 260 may comprise at least one of a display, a keyboard, a touchscreen, a vibrator arranged to signal to a user by causing device 200 to vibrate, a speaker and a microphone. A user may be able to operate device 200 via UI 260, for example to accept incoming telephone calls, to originate telephone calls or video calls, to browse the Internet, to manage digital files stored in memory 220 or on a cloud accessible via transmitter 230 and receiver 240, or via NFC transceiver 250, and/or to play games.

Device 200 may comprise or be arranged to accept a user identity module 270. User identity module 270 may comprise, for example, a Subscriber Identity Module, SIM, card installable in device 200. A user identity module 270 may comprise information identifying a subscription of a user of device 200. A user identity module 270 may comprise cryptographic information usable to verify the identity of a user of device 200 and/or to facilitate encryption of communicated information and billing of the user of device 200 for communication effected via device 200.

Processing unit 210 may be furnished with a transmitter arranged to output information from processing unit 210, via electrical leads internal to device 200, to other devices comprised in device 200. Such a transmitter may comprise a serial bus transmitter arranged to, for example, output information via at least one electrical lead to memory 220 for storage therein. Alternatively to a serial bus, the transmitter may comprise a parallel bus transmitter. Likewise processing unit 210 may comprise a receiver arranged to receive information in processing unit 210, via electrical leads internal to device 200, from other devices comprised in device 200. Such a receiver may comprise a serial bus receiver arranged to, for example, receive information via at least one electrical lead from receiver 240 for processing in processing unit 210. Alternatively to a serial bus, the receiver may comprise a parallel bus receiver.

Device 200 may comprise further devices not illustrated in FIG. 2. For example, where device 200 comprises a smartphone, it may comprise at least one digital camera. Some devices 200 may comprise a back-facing camera and a front-facing camera, wherein the back-facing camera may be intended for digital photography and the front-facing camera for video telephony. Device 200 may comprise a fingerprint sensor arranged to authenticate, at least in part, a user of device 200. In some embodiments, device 200 lacks at least one device described above. For example, some devices 200 may lack a NFC transceiver 250 and/or user identity module 270.

Processing unit 210, memory 220, transmitter 230, receiver 240, NFC transceiver 250, UI 260 and/or user identity module 270 may be interconnected by electrical leads internal to device 200 in a multitude of different ways. For example, each of the aforementioned devices may be separately connected to a master bus internal to device 200, to allow for the devices to exchange information. However, as the skilled person will appreciate, this is only one example and depending on the embodiment various ways of interconnecting at least two of the aforementioned devices may be selected without departing from the scope of the embodiments.

Embodiments of the present invention provide an improved antenna assembly for wireless devices operating on millimeter-wave frequencies. In general, such wireless devices need specific chipsets suitable for millimeter-wave signal. For example, in accordance with some embodiments a wireless device may need a multichannel millimeter-wave chipset and multiple antennas around the wireless device. More specifically, there may be a need for phased antenna arrays or switched antenna beams for beam steering.

However, at least one challenge is that distribution of millimeter-wave signals on a circuit, such as a Printed Circuit Board, PCB, may be lossy because the use of high frequencies causes high path losses. Millimeter-wave signals may refer to signals on frequency bands between 30 and 300 GHz. Thus, distribution of millimeter-wave signals, for example on a PCB, would require high transmission powers, which would further increase a temperature of a wireless device. Use of high transmission powers would also consume more power, leading to poor battery life.

An antenna assembly according to at least some embodiments of the present invention aims to address these challenges by enabling power efficient generation of millimeter-wave signals. According to at least some embodiments of the present invention a baseband and an oscillator signal may be diplexed and the diplexed signal may be distributed over a waveguide to an antenna element. The oscillator signal may be a Local Oscillator, LO, signal in some embodiments. Also, the antenna element may be active in some embodiments. In addition, the waveguide may be a single microwave waveguide. For example, if a frequency of a transmitted or received RF signal is 28 GHz, a frequency of the oscillator signal may between 9-10 GHz (3rd harmonic) or 6.5-7.5 GHz (4^{th} harmonic). Thus, in general the waveguide may be suitable for signals under 10 GHz.

Embodiments of the present invention provide easy distribution of signals to many antennas without high losses while enabling generation of millimeter-waves based on the distributed signals. Thus, for example, a regular, low cost multilayer PCB may be used in wireless devices. The baseband and the oscillator signals may be diplexed at a processing unit, such as a baseband ASIC, or near to the processing unit. Moreover, generation of the oscillator signal and diplexing may be performed outside of the processing unit or built-in to the processing unit. Separation of the baseband signal and the oscillator signal may be achieved using diplexers at the antenna assembly.

Moreover, the baseband signal and the oscillator signal may be mixed at the antenna assembly using subharmonic mixing. In general, a low frequency oscillator signal may be distributed with lower losses than a received RF signal or RF signal to be transmitted, because transmission of millimeter-waves is very lossy, e.g., on the PCB.

Architecture of the antenna assembly may depend on a duplexing method. For example, if Time Division Duplexing, TDD is used, wherein transmission and reception take place on the same frequency, the antenna assembly may comprise at least one switch for switching between transmission and reception modes using the same antenna. For example, TDD may be exploited in 5G systems and some embodiments of the present invention may be more suitable for TDD. TDD may be used in a half-duplex system and in such a case transmission and reception would be performed on the same frequency at different times.

On the other hand, if Frequency Division Duplexing, FDD, is used, wherein transmission and reception take place on different frequencies, the antenna assembly may comprise a transmit antenna chain for transmission and a receive antenna for reception. The transmit antenna chain may be associated with a first feed network while the receive antenna chain may be associated with a second feed network. In such a case, the transmit antenna chain may comprise a first generator for oscillator signals and the receive antenna chain may comprise a second generator for oscillator signals. That is to say, there may be separate generators for oscillator signals due to the use of different frequencies for transmission and reception.

In general, according to some embodiments of the present invention phase shifting may be done digitally in baseband or by analog shifting. As an example, digital phase shifting may be more useful in case of small antenna arrays.

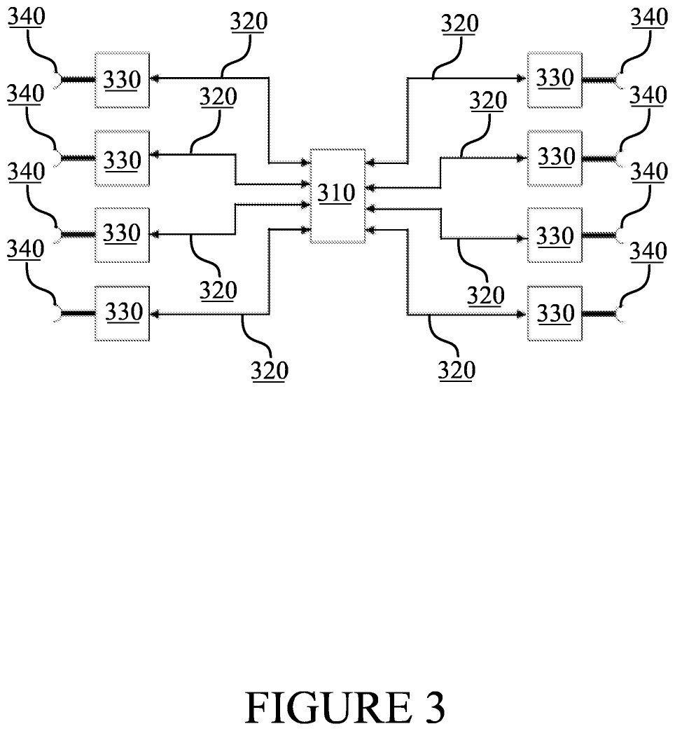

FIG. 3 illustrates an example structure of a wireless device in accordance with at least some embodiments of the present invention. The example structure of the wireless device of FIG. 3 comprises processing unit 310, which may correspond to processing unit 210 of FIG. 2.

The example structure of FIG. 3 also comprises waveguides 320, antenna frontends 330 and antennas 340. Even though 8 antennas 310 are shown in FIG. 3, embodiments of the present invention are not limited to any specific number of antennas. Each of the antennas 340 may be coupled to antenna frontend 330. As an example, antenna frontend 330 may refer to an active antenna frontend, i.e., antenna element, possibly comprising at least one integrated diplexer, at least one amplifier and at least one Single-Pole Double-Throw, SPDT, switch or Power Amplifier and Low Noise Amplifier, PALNA. Each antenna frontend 330 may be coupled to one waveguide 320 and waveguides 320 may be further coupled to processing unit 310. Thus, antennas 340 may be connected to processing unit 310 via antenna frontends 310 and waveguides 320.

Waveguide 320 may be, for example, a microstrip, Coplanar Waveguide, CPW, stripline or a Substrate Integrated Waveguide, SIW. Moreover, processing unit 310 may be an Application-Specific Integrated Circuit, ASIC. For instance, processing unit 310 may be a baseband ASIC, comprising an integrated Local Oscillator, LO, at least one diplexer and at least one SPDT switch.

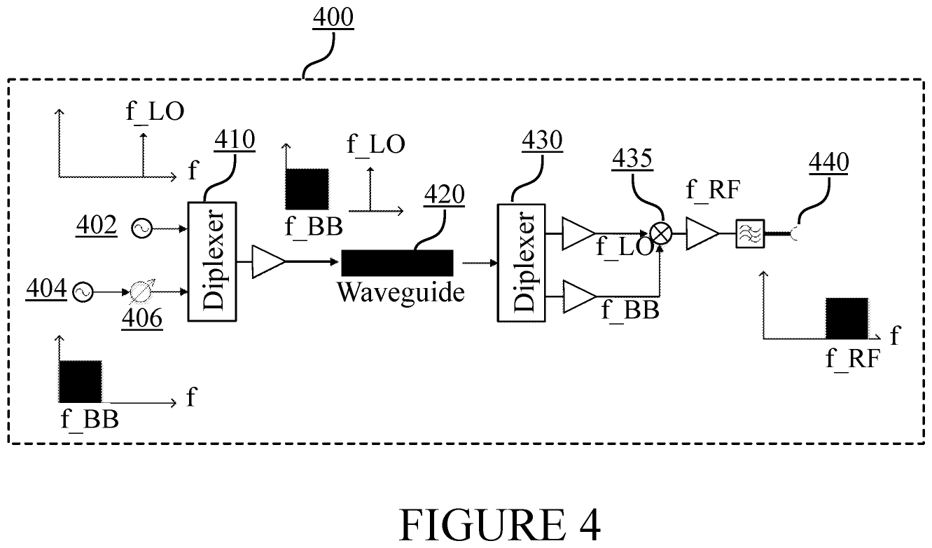

FIG. 4 illustrates an exemplary antenna assembly for a single transmitter chain using direct conversion in accordance with at least some embodiments of the present invention. The transmitter chain 400 may be referred to as a transmit antenna chain or an antenna assembly in general as well. In the exemplary antenna assembly of FIG. 4, the transmitter chain 400 may comprise first diplexer 410 coupled to oscillator 402 and baseband unit 404. In some embodiments, phase shifter 406 may be coupled with baseband unit 404 and first diplexer 410.

First diplexer 410 may receive an oscillator signal, e.g., a LO signal, from oscillator 402 on a first frequency denoted by f_LO. Also, first diplexer 410 may receive a baseband signal from baseband unit 404. Bandwidth of the baseband signal is denoted by f_BB. First diplexer 410 may generate a multiplexed signal by multiplexing the oscillator signal and the baseband signal in frequency domain.

First diplexer 410 may also be coupled to waveguide 420. Waveguide 420 may correspond to waveguide 320 of FIG. 3. Waveguide 420 may be coupled to first diplexer 410 and second diplexer 430. Waveguide 420 may carry the multiplexed signal from first diplexer 410 to second diplexer 430. Second diplexer 430 may demultiplex the multiplexed signal to regenerate the baseband signal and the LO signal. Second diplexer 430 may be coupled to waveguide 420 and a first and a second port of frequency mixer for millimeter-wave signals 435. Frequency mixer 435 may be referred to as a first frequency mixer for millimeter-wave signals in some embodiments. In the exemplary antenna assembly of FIG. 4, frequency mixer 435 may be an up-converter for millimeter-waves. That is to say, frequency mixer 435 may generate a millimeter-wave signal.

Second diplexer 430 may transmit the regenerated baseband signal and the regenerated oscillator signal to frequency mixer 435. For example, second diplexer 430 may transmit the regenerated baseband signal to the first port of frequency mixer 435 and the regenerated oscillator signal to the second port of frequency mixer 435.

Moreover, frequency mixer 435 may generate a millimeter-wave signal based on the regenerated baseband signal and the regenerated oscillator signal, received from second diplexer 430. Frequency mixer for millimeter-wave signals 435 may determine a frequency of the millimeter-wave signal by multiplying a frequency of the oscillator signal f_LO by an integer value N and generate the millimeter-wave signal by shifting the regenerated baseband signal to the frequency of the millimeter-wave signal. That is to say, if the millimeter wave signal is denoted by f_RF, it may be generated as follows

f_RF=N*f_LO±f_BB. (1)

Frequency mixer for millimeter-wave signals 435 may be coupled with antenna 440 via a third port of frequency mixer 435 and transmit the millimeter-wave signal to antenna 440. Moreover, antenna 440 may radiate, or transmit, the millimeter-wave signal. Antenna 440 may correspond to antenna 340 of FIG. 3. An amplifier and a band-pass filter may be inserted between frequency mixer 435 and antenna 440. The filter may be located before or after the amplifier in the transmitter chain.

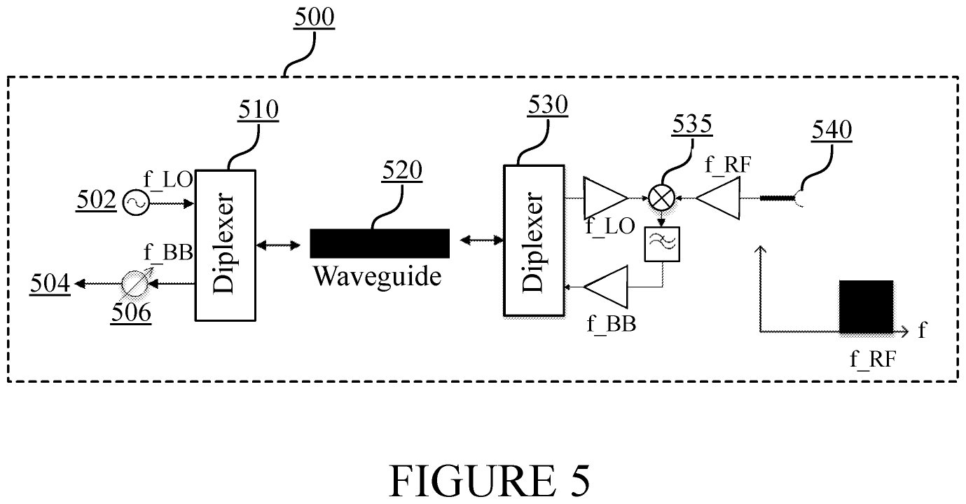

FIG. 5 illustrates an exemplary antenna assembly for a single receiver chain using direct conversion in accordance with at least some embodiments of the present invention. The receiver chain 500 may be referred to as a receive antenna chain or an antenna assembly in general as well. In FIG. 5, elements 502-540 may correspond to elements 402-440 of FIG. 4 and elements of FIG. 5 may be coupled together similarly as in the exemplary antenna assembly of FIG. 4 as well. In the exemplary antenna assembly of FIG. 5, antenna 540 may receive a millimeter-wave signal, f_RF, and forward the millimeter-wave signal to a third port of frequency mixer for millimeter-wave signals 535. In the exemplary antenna assembly of FIG. 5, frequency mixer 535 may be a down-converter for millimeter-waves. That is to say, frequency mixer for millimeter waves may down-convert a millimeter-wave signal to a baseband signal.

Frequency mixer for millimeter-wave signals 535 may receive, at a first port of frequency mixer 535, an oscillator signal from second diplexer 530. Moreover, frequency mixer 535 may generate a baseband signal, f_BB, based on the millimeter-wave signal f_RF and an oscillator signal f_LO. For example, the baseband signal f_BB may be generated by multiplying a frequency of the oscillator signal f_LO by an integer value N and shifting the received RF signal to the baseband. That is to say, the baseband signal f_BB may be generated as follows

f_BB=N*f_LO±f_RF. (2)

Second diplexer 530 may receive the generated baseband signal from frequency mixer for millimeter-wave signals 535. For example, second diplexer 530 may receive the baseband signal from a first port of frequency mixer 535. Moreover, second diplexer 530 may generate a multiplexed signal to waveguide 520 by multiplexing with the oscillator signal and the baseband signal in frequency domain.

Waveguide 520 may carry the multiplexed signal from second diplexer 530 to first diplexer 510. First diplexer 510 may receive the oscillator signal 502 on a first frequency denoted by f_LO and the multiplexed signal from second diplexer 530 via waveguide 520. First diplexer 510 may demultiplex the multiplexed signal to regenerate the baseband signal. Also, first diplexer 510 may transmit a baseband signal to baseband unit 504.

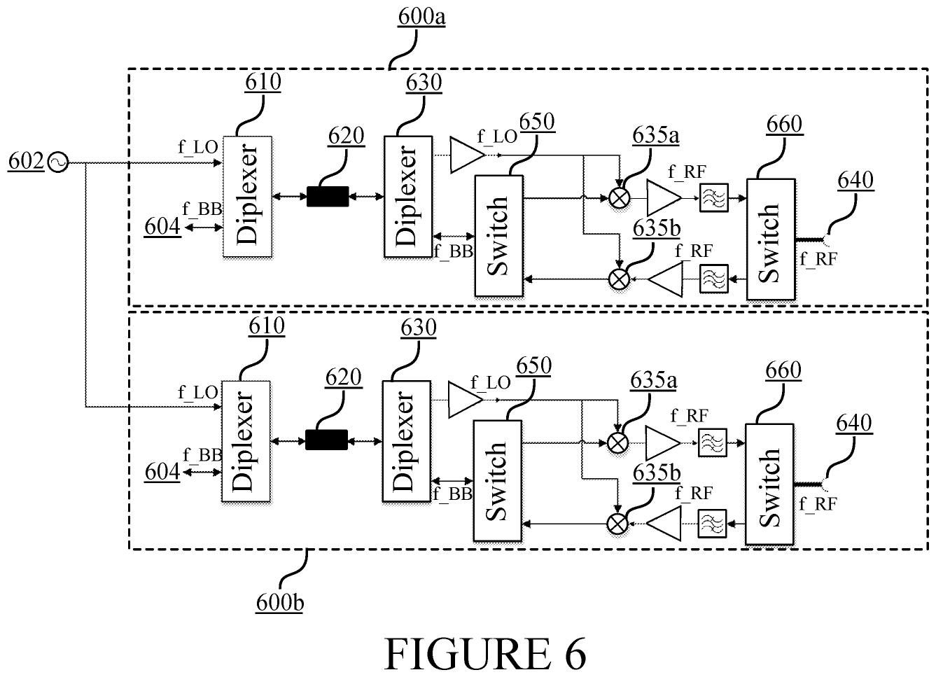

FIG. 6 illustrates an exemplary TDD multiplexing concept in accordance with at least some embodiments. In FIG. 6, elements 602-640 may correspond to elements 402-440 of FIG. 4. In the exemplary TDD multiplexing concept of FIG. 6, an antenna assembly comprising two transceiver chains 600a and 600b is shown, i.e., an antenna array is presented in FIG. 6. Transceiver chains 600a and 600b may be referred to as antenna chains in general.

Moreover, FIG. 6 also comprises first switches 650 and second switches 660. Switches 650 and 660 may be suitable for switching an antenna assembly, or a transceiver chain, from a transmission mode to a reception mode or from the reception mode to the transmission mode. As an example, switches 650 and 660 may be SPDT switches.

Similarly as in FIGS. 4 and 5, first diplexers 610 may be coupled to oscillators 602 and baseband units 604. First diplexers 610 may receive oscillator signals from oscillators 602 on a first frequency denoted by f_LO. Also, first diplexers 610 may transmit, or receive, baseband signals to, or from, baseband units 604. Bandwidth of the baseband signals is denoted by f_BB. When antenna assembly 600a, 600b is used for transmitting, first diplexers 610 may generate multiplexed signals by multiplexing the oscillator signals and the baseband signals in frequency domain.

First diplexers 610 may also be coupled to waveguides 620. Waveguides 620 may be coupled to first diplexers 610 and second diplexers 630. Waveguides 620 may carry multiplexed signals between first diplexers 610 and second diplexers 630. If an antenna assembly is used for transmitting, second diplexers 630 may demultiplex the received multiplexed signals to regenerate the baseband signals and the oscillator signals.

Second diplexers 630 may be coupled to waveguides 620 along with a first port of first frequency mixers 635a, a first port of second frequency mixers 635b and a first port of first switches 650. Second diplexers 630 may transmit, or receive, the regenerated baseband signal to, or from, the first port of first switches 650. Also, second diplexers 630 may transmit the regenerated oscillator signal to the first port of first switches 660 and the first port of second frequency mixers 635b.

In the exemplary TDD multiplexing concept of FIG. 6, frequency mixers for millimeter waves 635a may be up-converters for millimeter-waves, for generating a millimeter-wave signal for transmission. Moreover, frequency mixers for millimeter waves 635b may be down-converters for millimeter-waves, for down-converting a millimeter-wave signal to a baseband signal when receiving. For example, TDD mode selection (transmitting or receiving mode) may be controlled by the processing unit 310 and initiated by controlling the switches 650 and 660 accordingly.

First switches 650 may be coupled to a second port of first frequency mixers 635a and when an antenna assembly is used for transmitting, first switches 650 may transmit the regenerated baseband signals to the second port of first frequency mixers 635a. First switches 650 may be coupled to a second port of second frequency mixers 635b as well and if an antenna assembly is used for receiving, second switches 650 may receive the regenerated baseband signals from the second port of second frequency mixers 635b.

Moreover, when the antenna assembly is used for transmitting, or configured to transmit, first frequency mixers 635a may generate a millimeter-wave signal based on the regenerated baseband signals and the regenerated oscillator signal, similarly as described in connection with FIG. 4, e.g., using equation 1. First frequency mixers 635a may be coupled with second switches 660 via a third port of first frequency mixers 635a. First frequency mixers 635a may transmit the millimeter-wave signals to antennas 640 via second switches 660. That is to say, first frequency mixers 635a may be connected to antennas 640 via second switches 660. Moreover, antennas 640 may radiate, or transmit, the millimeter-wave signals.

Correspondingly, second frequency mixers 635b may be coupled with antenna 640 via a third port of second frequency mixers 635b. When the antenna assembly is used for receiving, or configured to receive, frequency mixers 635b may receive, at a first port of second frequency mixers 635b, an oscillator signal from second diplexer 630. Also, antennas 640 may receive a millimeter-wave signal, f_RF, and forward the millimeter-wave signals to a third port of second frequency mixers 635b via second switches 660. When the transceiver is receiving, second frequency mixers 635b may generate a baseband signal similarly as described in connection with FIG. 5, e.g, using equation 2.

In some embodiments, first diplexer 610 of second transceiver chain 600b may be referred to as a third diplexer. Also, in some embodiments, second diplexer 630 of second transceiver chain 600b may be referred to as a fourth diplexer. Waveguide 620 of first transceiver chain 600a may be referred to as a first waveguide and waveguide 620 of second transceiver chain 600b may be referred to as a second waveguide coupled with the third diplexer and the fourth diplexer. In some embodiments, antenna 640 of first transceiver chain 600a may be referred to as a first antenna and antenna 640 of second transceiver chain 600b may be referred to as a second antenna.

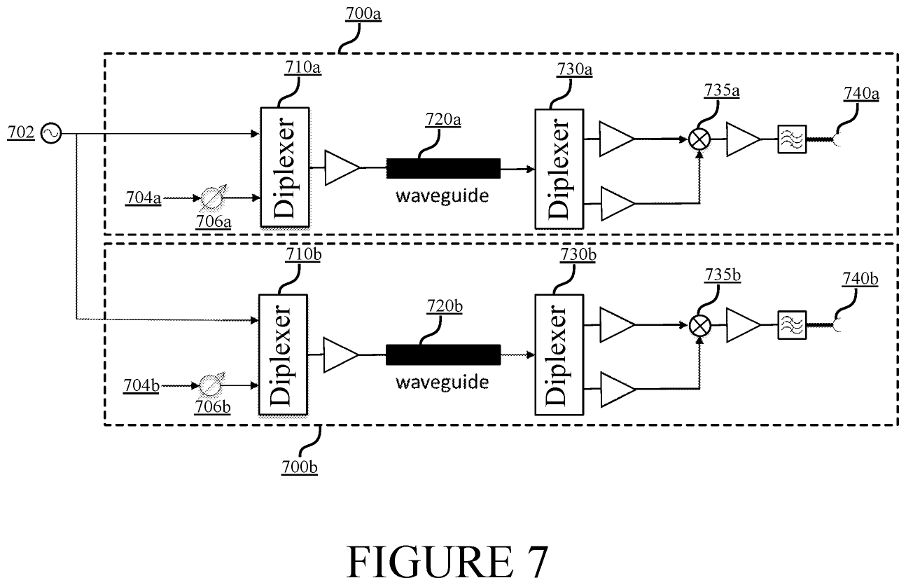

FIG. 7 illustrates an exemplary transmit antenna array concept in accordance with at least some embodiments. The exemplary transmit antenna array concept may be a multichannel phased-array concept for FDD. The transmit antenna array concept may be suitable for TDD as well. In FIG. 7, an antenna assembly comprising two transmitter chains 700a and 700b is shown, i.e., an antenna array is presented in FIG. 7. Transmitter chains 700a and 700b may be referred to as antenna chains in general. Elements 702-740 in FIG. 7 may correspond to elements 402-440 of FIG. 4. That is to say, both of transmitter chains 700a and 700b shown in FIG. 7 may correspond to transmitter chain 400 of FIG. 4. Transmitter chains 700a and 700b may operate simultaneously in the same way as transmitter chain 400 of FIG. 4.

In FIG. 7, first transmitter chain 700a may comprise at least some of the following elements: first baseband unit 704a, first phase shifter 706a, first diplexer 710a, first waveguide 720a, second diplexer 730a, first frequency mixer for millimeter-wave signals 735a and first antenna 740a. Similarly, second transmitter chain 700b may comprise at least some of the following elements: second baseband unit 704b, second phase shifter 706b, third diplexer 710b, second waveguide 720b, fourth diplexer 730b, second frequency mixer for millimeter-wave signals 735b and second antenna 740b.

In the exemplary transmit antenna array concept of FIG. 7, frequency mixers 735a and 735b may be up-converters for millimeter-waves, for generating millimeter-wave signals for transmission.

First transmitter chain 700a and second transmitter chain 700b may be arranged similarly as transmitter chain 400 of FIG. 4. So as an example, third diplexer 710b may be coupled with second baseband unit 704b and oscillator 702. Fourth diplexer 730b may be coupled with a first port of second frequency mixer for millimeter-wave signals 735b and connected to a second port of second frequency mixer for millimeter-wave signals 735b. Moreover, second waveguide 720b may be coupled with third diplexer 710b and fourth diplexer 730b. Second frequency mixer for millimeter-wave signals 735b may also be coupled to second antenna 740b via a third port of second frequency mixer for millimeter-wave signals 735b. First transmitter chain 700a and second transmitter chain 700b may operate similarly as transmitter chain 400 of FIG. 4 as well.

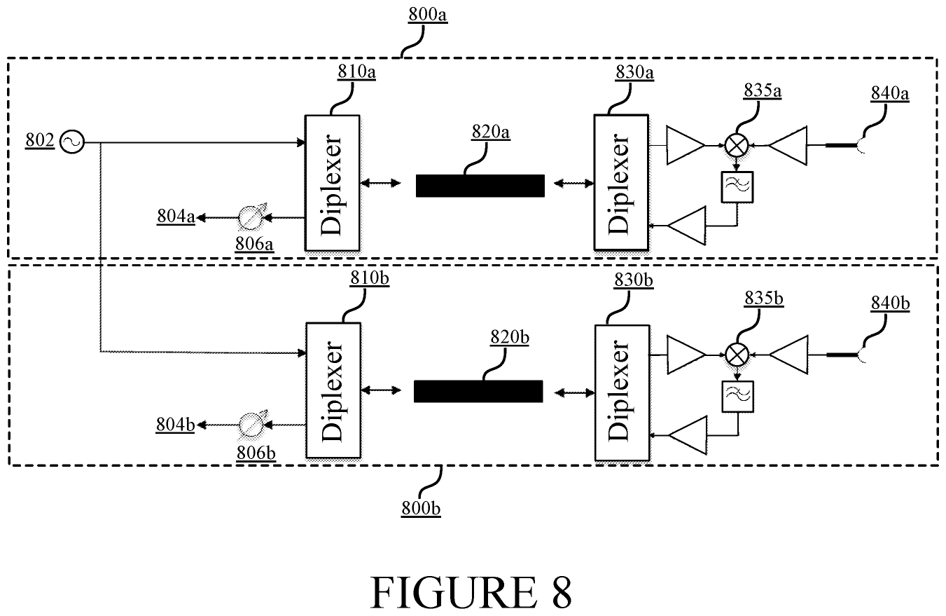

FIG. 8 illustrates an exemplary receive antenna array concept in accordance with at least some embodiments. The exemplary receive antenna array concept may be a multichannel phased-array concept for FDD. The receive antenna array concept may be suitable for TDD as well. In FIG. 8, an antenna assembly comprising two receiver chains 800a and 800b is shown, i.e., an antenna array is presented in FIG. 8. Receiver chains 800a and 800b may be referred to as antenna chains in general. Elements 802-840 of FIG. 8 may correspond to elements 502-540 of FIG. 5. That is to say, both receiver chains 800a and 800b shown in FIG. 8 may correspond to receiver chain 500 of FIG. 5. Receiver chains 800a and 800b may operate simultaneously in the same way as transmitter chain 500 of FIG. 5.

In FIG. 8, first receiver chain 800a may comprise at least some of the following elements: first baseband unit 804a, first phase shifter 806a, first diplexer 810a, first waveguide 820a, second diplexer 830a, first frequency mixer for millimeter-wave signals 835a and first antenna 840a. Similarly, second receiver chain 800b may comprise at least some of the following elements: second baseband unit 804b, second phase shifter 806b, third diplexer 810b, second waveguide 820b, fourth diplexer 830b, second frequency mixer for millimeter-wave signals 835b and second antenna 840b.

In the exemplary receive antenna array concept of FIG. 8, frequency mixers 835a and 835b may be down-converters for millimeter-waves, for down-converting a millimeter-wave signal to a baseband signal.

First receiver chain 800a and second receiver chain 800b may be arranged similarly as transmitter chain 500 of FIG. 5. So as an example, third diplexer 810b may be coupled with second baseband unit 804b and oscillator 802. Fourth diplexer 830b may be coupled with a first port of second frequency mixer for millimeter-wave signals 835b and connected to a second port of second frequency mixer for millimeter-wave signals 835b. Moreover, second waveguide 820b may be coupled with third diplexer 810b and fourth diplexer 830b. Second frequency mixer for millimeter-wave signals 835b may also be connected to second antenna 840b via a third port of second frequency mixer for millimeter-wave signals 835b. First receiver chain 800a and second receiver chain 800b may operate similarly as transmitter chain 500 of FIG. 5 as well.

Even though FIGS. 6, 7 and 8 illustrate two chains for transmission and/or reception, there may naturally be more than two chains as well. In fact, typically there are more than two chains. For example, 8 chains may be needed for beamforming and/or Multiple-Input Multiple-Output, MIMO.

In some embodiments, transmit antenna array of FIG. 7 and receive antenna array of FIG. 8 may be separate transmission and reception chains, respectively, which are suitable for both, FDD and TDD.

In general, the exemplary antenna assemblies may also comprise amplifiers and filters, however, embodiments of the present invention are not limited to any specific number or position of amplifiers and filters. In fact, in some embodiments there may be no amplifiers or filters. That is to say, use and organization of amplifiers and filters may be decided in the planning phase.

Phase shifters may be used for forming beams. For example, phase shifters may be used for shaping the beams and/or steering the beams.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

In an exemplary embodiment, an apparatus, such as, for example, a wireless terminal or a wireless network node, may comprise means for carrying out the embodiments described above and any combination thereof.

In an exemplary embodiment, a computer program may be configured to cause a method in accordance with the embodiments described above and any combination thereof. In an exemplary embodiment, a computer program product, embodied on a non-transitory computer readable medium, may be configured to control a processing unit to perform a process comprising the embodiments described above and any combination thereof.

In an exemplary embodiment, an apparatus, such as, for example, a wireless terminal or a wireless network node, may comprise at least one processing unit, and at least one memory including computer program code, wherein the at least one memory and the computer program code are configured to, with the at least one processing unit, cause the apparatus at least to perform the embodiments described above and any combination thereof.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

In an exemplary embodiment, an apparatus, such as an antenna array, may include means for carrying out embodiments described above and any combination thereof.

### INDUSTRIAL APPLICABILITY

At least some embodiments of the present invention find industrial application in wireless communication systems operating on millimeter-waves.

### ACRONYMS LIST

5G 5^{th} Generation
ASIC Application-Specific Integrated Circuit
BS Base station
CPW Coplanar Waveguide
FDD Frequency Division Duplexing
FPGA Field-Programmable Gate Array
GSM Global System for Mobile communication
Iot Internet of Things
LTE Long Term Evolution
LO Local Oscillator
M2M Machine-to-Machine
MIMO Multiple-Input Multiple-Output
MTC Machine-Type Communications
NFC Near-Field Communication
NR New Radio
PALNA Power Amplifier and Low-Noise Amplifier
PCB Printed Circuit Board
RAM Random-Access Memory
RAT Radio Access Technology
RF Radio Frequency
SIM Subscriber Identity Module
SIW Substrate Integrated Waveguide
SPDT Single-Pole Double-Throw
TDD Time Division Duplexing
UE User Equipment
UI User Interface
WCDMA Wideband Code Division Multiple Access
WiMAX Worldwide Interoperability for Microwave Access
WLAN Wireless Local Area Network

REFERENCE SIGNS LIST

| | |
|---|---|
| 110, 120 | Wireless terminals |
| 130 | Wireless network node |
| 115, 125 | Air interface |
| 200-270 | Structure of the apparatus of FIG. 2 |
| 310 | Processing unit |
| 320, 420, 520, 620, 720a, | Waveguide |
| 720b, 820a, 820b | |
| 330 | Antenna frontend |
| 340, 440, 540, 640, 740a, | Antenna |
| 740b, 840a, 840b | |
| 400, 500, 600a, 600b, 700a, | Antenna chain |
| 700b, 800a, 800b | |
| 402, 502, 602, 702, 802 | Oscillator |
| 404, 504, 604, 704a, 704b, | Baseband unit |
| 804a, 804b | |
| 406, 506, 606, 706a, 706b, | Phase shifter |
| 806a, 806b | |
| 410, 510, 610, 710a, 710b, | First diplexer |
| 810a, 810b | |
| 430, 530, 630, 730a, 730b, | Second diplexer |
| 830a, 830b | |
| 435, 535, 635a, 635b, 735a, | Frequency mixer |
| 735b, 835a, 835b | |
| 650 | First switch |
| 660 | Second switch |

1. An antenna assembly for millimeter-wave signals, comprising:
a first diplexer coupled with a baseband unit and an oscillator;
a second diplexer coupled with a first port of a frequency mixer for millimeter-wave signals and connected to a second port of the frequency mixer for millimeter-wave signals;
a waveguide coupled with the first diplexer and the second diplexer; and
the frequency mixer for millimeter-wave signals being connected to an antenna via a third port of the frequency mixer for millimeter-wave signals.

2. The antenna assembly according to claim 1, further comprising:
a processing unit comprising the baseband unit and the oscillator.

3. The antenna assembly according to claim 1, further comprising:
a processing unit comprising the first diplexer.

4. The antenna assembly according to claim 1, further comprising:
a processing unit coupled to the first diplexer.

5. The antenna assembly according to claim 1, further comprising:
a phase shifter coupled to the baseband unit and the first diplexer.

6. The antenna assembly according to claim 1, wherein the frequency mixer for millimeter-wave signals is coupled to the antenna via the third port.

7. The antenna assembly according to claim 1, wherein the antenna assembly is for Frequency Division Duplexed, FDD, transmissions.

8. The antenna assembly according to claim 1, further comprising:
a first switch coupled to the second diplexer and to the frequency mixer for millimeter-wave signals; and
a second switch coupled to the frequency mixer for millimeter-wave signals and the antenna.

9. The antenna assembly according to claim 8, wherein the second diplexer is connected to the second port of the frequency mixer for millimeter-wave signals via the first switch and the frequency mixer for millimeter-wave signals is connected to the antenna via the second switch.

10. The antenna assembly according to claim 1, wherein the antenna assembly is for Time Division Duplexed, TDD, transmissions.

11. The antenna assembly according to claim 1, wherein the waveguide is for microwave signals, possibly for microwave signals under 10 GHz.

12. The antenna assembly according to claim 1, wherein the waveguide is mounted on a Printed Circuit Board, PCB.

13. An antenna array comprising the antenna assembly according to claim 1, wherein the antenna assembly forms an antenna chain of the antenna array and the antenna array comprises a plurality of said antenna chains.

14. A wireless terminal comprising the antenna assembly according to claim 1.

15. The wireless terminal according to claim 14, wherein the wireless terminal is a User Equipment, UE.

16. A wireless terminal comprising the antenna array according to claim 13.

17. The wireless terminal according to claim 16, wherein the wireless terminal is a User Equipment, UE.
